(19) United States
(12) Patent Application Publication
(10) Pub. No.: US 2010/0169357 A1
(43) Pub. Date: Jul. 1, 2010

(54) Method, Apparatus, and Computer Program Product for Automatically Obtaining Custom Interface Elements When Changing UI Themes by Querying a Remote Repository

(76) Inventors: Michael Ingrassia, Dallas, TX (US); Chitturi Suresh, Plano, TX (US); Tolga Capin, Fort Worth, TX (US); Koichi Mori, Irving, TX (US)

Correspondence Address: HARRINGTON & SMITH, 4 RESEARCH DRIVE, Suite 202, SHELTON, CT, 06484-6212, US

(21) Appl. No.: 11/989,845

(22) PCT Filed: Aug. 1, 2005
(86) PCT No.: PCT/IB2005/002272

§ 371 Date: Mar. 2, 2010

(51) Int. Cl. G06F 17/30; G06F 3/048

(52) U.S. Cl. 707/769; 715/810; 707/E17.014

(57) ABSTRACT

A method including forming a query to specifically request at least one user interface element not resident upon a device, transmitting the query to a remote repository comprising a plurality of user interface element definitions, dynamically retrieving response data from the remote repository in response to the query, and applying the response data to a user interface of the device.

### TECHNICAL FIELD

This invention relates generally to user interfaces, and more particularly, relates to customizable user interfaces.

### BACKGROUND

It is known in the art to access components remote from a computing device as well as to alter user interface elements. Examples of such art include U.S. Pat. No. 6,100,888 to Guordal et al. issued Aug. 8, 2000, U.S. Pat. No. 6,031,532 to Guordal et al. issued Feb. 29, 2000, and U.S. Pat. Pub. No. US 2004/0158811 A1 to Guthrie et al. published Aug. 12, 2004.

The user interface of the typical personal computing device supports a wide range of customizable features. Items like color schemes, visual design of icons, and customized sound events can be personalized by the user. To simplify customization settings some systems support the logical grouping of these settings into themes. Loading a particular theme will automatically change all of the device's settings at once, thus saving the user from having to change the settings individually themselves.

Some advanced personal computing devices support user customization of the look and feel of individual user interface (UI) elements, such as widgets, in addition to themes. For example, with reference to FIGS. 1 and 2, there is illustrated a plurality of dialog boxes 12 allowing a user operating in a Windows XP™ environment to select between using the “Windows Classic UI” (as in FIG. 1a) and the “Windows XP UI” (as in FIG. 1b). In FIGS. 2a-2b there is illustrated a second example of the GNOME Desktop operating on a Linux' device which allows a user to define and use different theme packages that define a new look and feelfor the entire system, including widgets, application borders and system icons.

It is helpful to define several terms used when describing the art. A “skin” is an application level definition that specifies the look and feel of a single application on a device. Changing a skin for one application has no effect on other applications running on the same device. An example known in the art can be seen in skins for WinAmp or Windows Media Player employed on computers running Microsoft Windows™.

A “theme” likewise changes the look and feel of the UI, but is different in several distinct ways from a skin. First, a theme changes the look and feel of elements on a system level. This means that changing the UI theme used on a device affects all applications running on the device. Second, a theme usually allows more than just the look and feel to be changed. Sounds can be associated with particular UI events such as errors or warnings. Lastly, a theme definition usually includes such specifications as which screen saver to use and other system preferences.

Lastly, a “widget” is a system UI control that accepts user input from, or displays information to, the user. In the domain of UNIX™ terminology, such controls are referred to as widgets, while in the Windows domain such controls are typically referred to as “controls”. For the sake of consistency, all such controls are referred to herein as “widgets”. Widgets come in a wide variety of types. Some common types of widgets include, but are not limited to, a “text box”, “radio button”, “drop-down list”, “command button”, “tree view”, “check box”, etc.

As noted, it is common for personal computing devices to allow user customization of the graphical user interface of the device. Simple attributes such as color scheme and text size are the most typical attributes to alter. Some advanced devices support the user customization of the look and feel of the UI widgets in the system, while many systems include support for theme management.

Currently, if the user wants to install a new theme on a device it is necessary to 1) find a location where there is stored the theme package for the particular platform upon which they are operating and the device and software version they are using, 2) download the theme, 3) download any necessary extensions to the system that are required by the theme, and 4) install all of the pieces, often times engaging in the manual copying of files to the correct location. The problem, as viewed by the user, is a vast sea of theme packages for a multitude of platforms and devices. For the novice user this can be quite daunting.

Similar complexities confront a designer of themes. Currently a designer of themes must 1) decide which platform and device to support, 2) create the content for the theme such as widget definitions and related materials, and 3) package all of the material together for that specific platform and device to form a theme package. If the designer wants to create the same theme for a different device, it is necessary to repeat the process again. Such repetition is a time consuming activity. Another problem with the current scheme is that the designer must recreate the theme materials and distribution for every platform that they want to support. Even though most platforms share a common set of widget definitions, the designer must duplicate this effort repeatedly. If the designer wants to create a theme for a new platform, the designer must redesign and include everything from scratch.

Service providers offer theme definitions provided by the various designers to users. Under the current system this can waste storage space. Themes for many different platforms have a number of widget definitions in common. For example, most systems have the concept of a “command button”, “text box”, “check box” and “list”. Under the current scheme, storage space is wasted on the service provider since each theme is packaged for each supported platform and has to include duplicate definitions for the common widgets.

There therefore exists a need for a technique by which theme definitions can be efficiently created, stored and accessed by users desiring to deploy a theme on a device. Such a technique would be of benefit to mobile operators, content designers, and application developers.

### SUMMARY OF THE PREFERRED EMBODIMENTS

In accordance with an exemplary embodiment of the invention a method comprises forming a query to specifically request at least one user interface element not resident upon a device, transmitting the query to a remote repository comprising a plurality of user interface element definitions, dynamically retrieving response data from the remote repository in response to the query, and applying the response data to a user interface of the device.

In accordance with a further exemplary embodiment of the invention a system comprises a means for forming a query to request at least one user interface element not resident upon a device, a means for transmitting the query to a remote repository comprising a plurality of user interface element definitions, a means for dynamically retrieving response data from the remote repository in response to the query, and a means for applying the response data to a user interface of said device.

In accordance with another exemplary embodiment of the invention a program of machine-readable instructions, tangibly embodied on an information bearing medium and executable by a digital data processor, to perform actions directed toward modifying a user interface, the actions comprises forming a query to request at least one user interface element not resident upon a device, transmitting the query to a remote repository comprising a plurality of user interface element definitions, receiving a response from the remote repository comprising at least one user interface element definition, and modifying a user interface of the device in response to the response.

### BRIEF DESCRIPTION OF THE DRAWINGS

The foregoing and other aspects of these teachings are made more evident in the following Detailed Description, when read in conjunction with the attached Drawing Figures, wherein:

FIG. 1a is an exemplary embodiment of a prior art user interface for selecting a theme.

FIG. 1b is an exemplary embodiment of a prior art user interface for selecting a theme.

FIG. 2a is an exemplary embodiment of a prior art user interface incorporating a theme.

FIG. 2b is an exemplary embodiment of a prior art user interface incorporating a theme.

FIG. 3 is an illustration of an exemplary embodiment of a system for practicing the invention.

FIG. 4 is an illustration of an exemplary theme and widget table entry.

FIG. 5 is a logic flow diagram of an exemplary embodiment of the method of the invention.

FIG. 6 is a Venn diagram of an exemplary embodiment of the repository.

FIG. 7a is an exemplary embodiment of a user interface comprised,of incongruent icons.

FIG. 7b is an exemplary embodiment of a user interface comprised of congruent icons.

FIG. 8 is a logic flow diagram of an exemplary embodiment of the method of the invention.

FIG. 9 is an illustration of an exemplary style definition table entry.

FIG. 10a is an illustration of an exemplary user interface to which is applied a style definition.

FIG. 10b is an illustration of an exemplary user interface to which is applied a style definition.

FIG. 11 is a logic flow diagram of an exemplary embodiment of the method of the invention.

FIG. 12 is a diagram of a mobile station according to an exemplary embodiment of the invention.

FIG. 13 is an illustration of an exemplary embodiment of a system for practicing the invention.

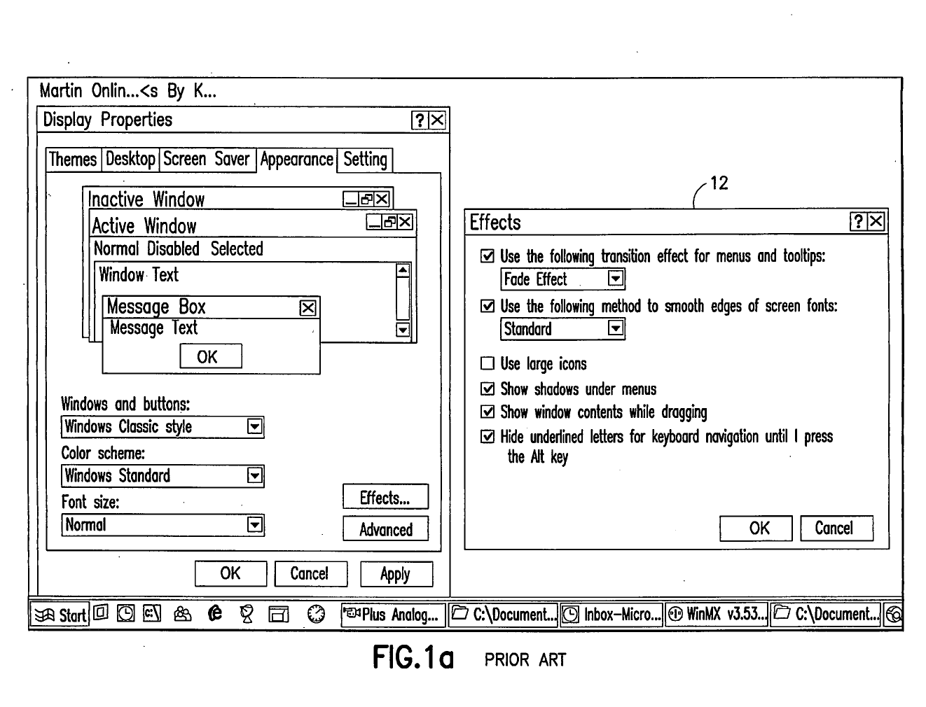

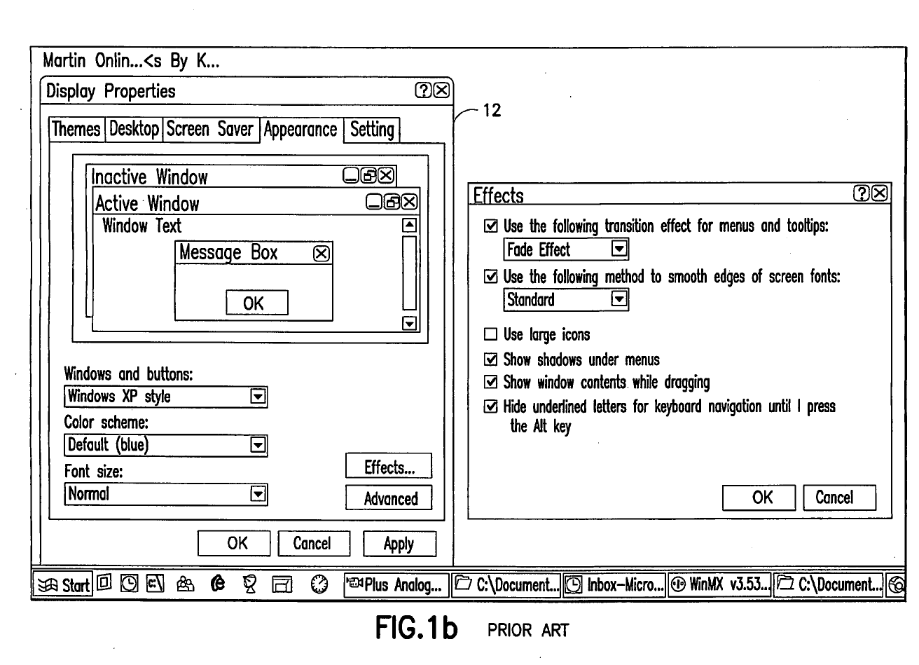

### DETAILED DESCRIPTION

In an exemplary embodiment of the present invention, there is provided a method for storing device independent, as well as device dependent, UI data, including, but not limited to theme data, style data, icons, and widgets, in a repository for access by users of a UI enabled device. As is described more fully below, the storage of such UI data on a repository capable of being accessed remotely by a user, allows for changes to be made to the UI of a device in a manner which requires a relatively low level of effort on the part of the user and which implements desired changes in an efficient manner.

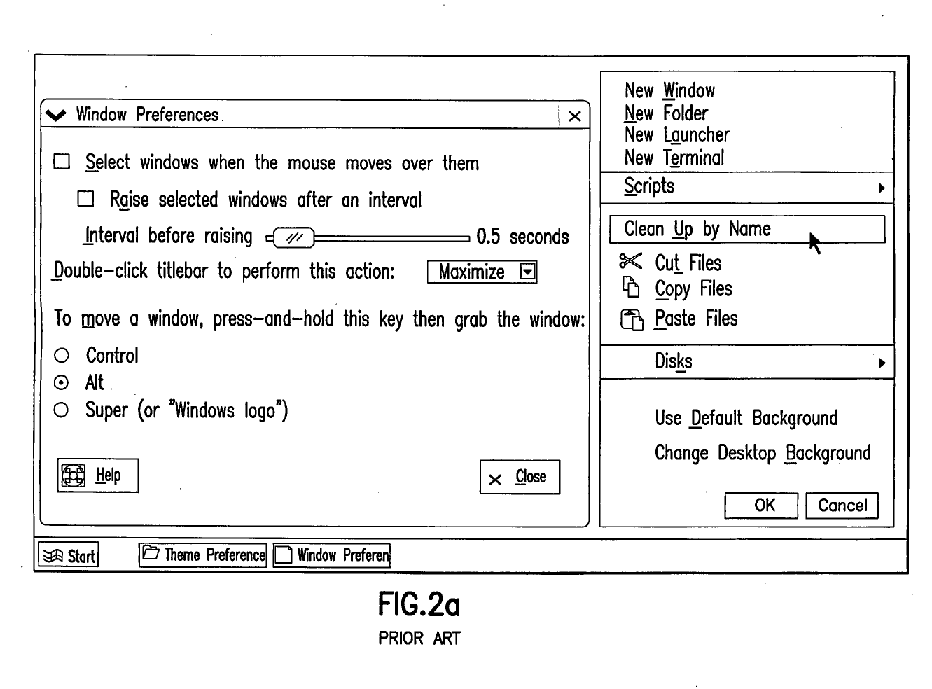

With reference to FIG. 3, there is illustrated a configuration of a system for practicing an exemplary embodiment of the invention. Device 10 is a computing device upon which is resident a graphical user interface (GUI) 15. Device 10 may be any digital computing device including, but not limited to, personnel computers (PCs), laptop computers, notebook computers, personal digital assistants (PDAs), mobile telephones, and the like.

Device 10 is in bi-directional communication with repository 20 via link 17. While illustrated as a wireless link 17, link 17 may be a hardwire connection or any other form of connection that enables device 10 to transmit and receive digital data to and from repository 20.

Repository 20 stores UI data and is capable of responding to requests for UI data stored within repository 20 by retrieving the requested UI data and transmitting the requested UI data to a device 10 via link 17. Repository 20 may store, as non-limiting examples, widget definitions, icon definitions, UI style definitions, and theme definitions, collectively “UI element definitions” 21. With particular reference to widgets and themes, repository 20 may store definitions for widget types corresponding to a multitude of available themes.

In an exemplary embodiment, repository 20 stores UI element definitions 21 in a relational database. As a result, each widget definition may be attributed with the identifiers for themes with which the widget definition is compliant and, if the definition is device dependent, the device identifiers of all devices for which the widget definition is valid. Each widget definition may likewise include an attribute specifying all of the themes for which the widget definition is valid.

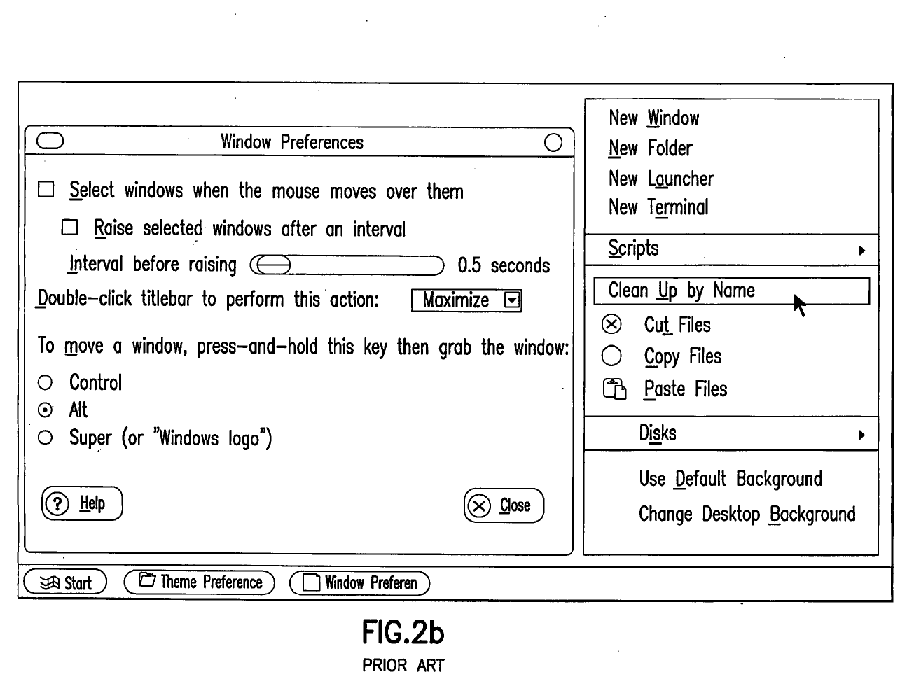

With reference to FIG. 4, there is illustrated an example of table entries for a database residing on repository 20 for a widget and a theme. A widget type of “list box” having a widget id of “0143” possesses attributes indicating that the widget, as defined, is compatible with themes “classic” and “futuristic” and that it is compatible with PDAs and PCs. In addition to these attributes, a generic widget definition 41 is illustrated. Widget definition 41 may be formed of any format of data describing, or enabling the description of, the widget. Widget definition 41 could contain data formed of a bitmap or other image file format to describe the appearance of the widget. Widget definition could likewise contain a pointer or other addressing mechanism, such as a uniform resource identifier (URI), to indicate a local or remote location of the additional widget definition 41 data. In addition, the widget definition 41 data may contain several image files at differing resolutions corresponding to the differing screen resolutions of supported devices or platforms, or, conversely, may contain a single scale independent widget definition 41, such as provided by the scalable vector graphics (SVG) format.

There is also illustrated an exemplary table entry for a theme having a theme id of “0117” and a theme type of “classic”. While illustrated as a numeric value, the theme id may be referenced, as described below, using a naming convention similar to the manner in which extensible markup language (XML) namespaces are defined. The theme id has, as attributes, one or more widget ids corresponding to widgets which are included in the theme. As noted in the example discussed above, the table entry for widget id “0143” defines the widget as compatible with the theme “classic”. One will note that the theme id “0117” is of a type “classic” and, therefore, lists widget id “0143” as a component widget. The universe of attributes associated with a theme id, including, but not limited to, widget ids and theme types, fully define a theme.

While described with reference to a repository 20 hosting a relational database, the invention is broadly drawn to any form of data repository capable of storing and retrieving UI data as described more fully below.

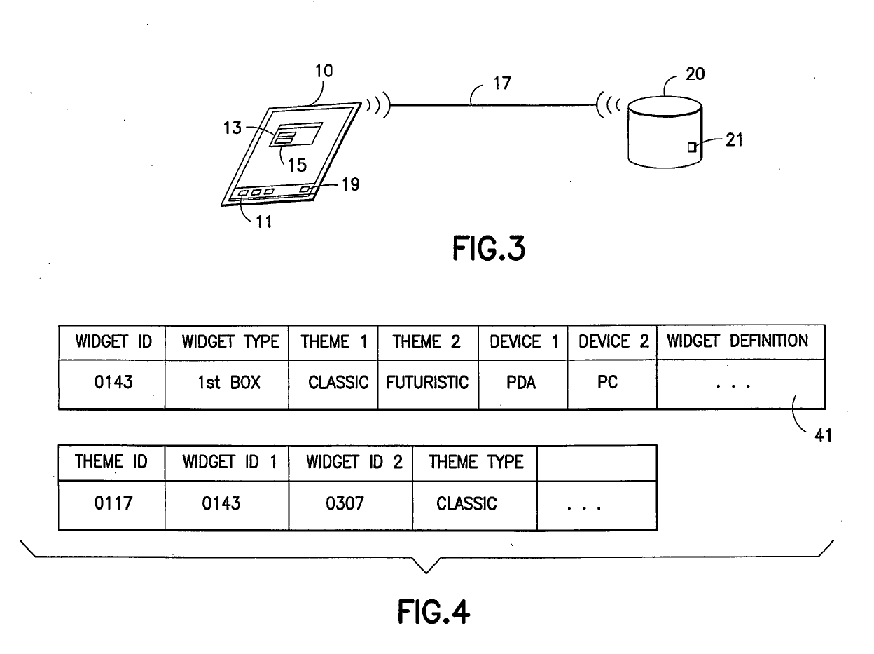

The general form and function of repository 20 having now been described, it is possible to discuss the interaction of a device 10 and a repository 20 remote from the device 10. With reference to FIG. 5, there is illustrated a logic flow diagram of the method whereby UI data is requested and utilized. At step 1, a request is formulated for UI data, for example, data related to a selected theme. In an exemplary embodiment, device 10 incorporates a user interface 15 through which a selection of a theme may be made. For example, a user may decide, via clicking on a selection in a list box, to apply the “classic” theme.

At step 2, a processor 19 coupled to, or resident within, device 10 and capable of executing instructions such as those defined in software,receives the user's selection of “classic” and formats a request, or query, to the repository 20 to retrieve all of the relevant UI element definitions corresponding to the requested theme. In an exemplary instance, the query may include only the theme id or theme type. In such an instance, the repository would return all widget definition 41 data corresponding to widgets which have “classic” as a theme attribute. Note that the repository retrieves the requested widget definitions 41 and dynamically creates a response to the query. By “dynamically creates” it is meant that the content of the response is created in response to, and is dependent upon, the content of the query and, therefore, does not exist in finished form prior to creation. In another exemplary embodiment, the query may include a theme identifier (id) as well as an explicit listing of the widgets definition 41 data required. In such an instance, the requested user interface elements are specifically identified for retrieval. For example, the communication between the device 10 and the repository 20 can be performed using HyperText Transfer Protocol (HTTP) wherein the request is formatted as follows:

```
GET THEME
      THEME_ID=”http://www.nokia.com/classic/2004”
      WIDGET_TYPES=”text/entry, list/select,
      button/command, button/radio,
      button/toggle”
```

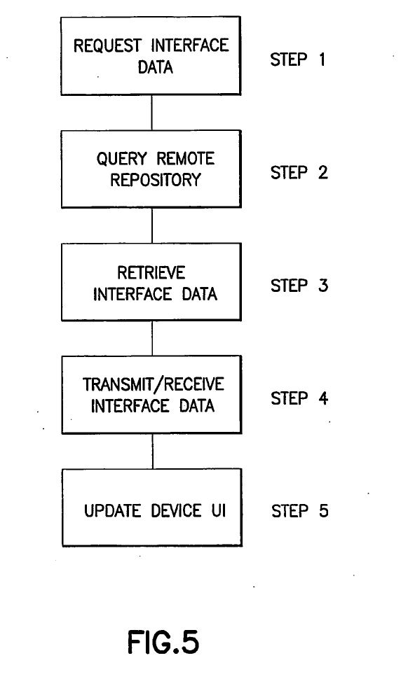

In addition to this example, further information may be embedded in the request. For example, a desired resolution or a device type may be included. By including such additional information, only the widgets comprising a theme which are additionally supported by a particular device need be accessed and transmitted to the device 10. With reference to FIG. 6, there is illustrated an exemplary Venn diagram of the possible intersection of widget definitions 41 in the universe of all widget types stored in the repository 20.

Returning to FIG. 5, at step 3, the repository 20 retrieves the UI data defined by the device's 10 query and, at step 4, responds to device 10 with the widget definitions 41. As noted, widget definitions 41 may take the form of data describing the attributes of a widget or widgets, or may take the form of a URI specifying where the widget definitions 41 can be obtained. For example, a response that returns the actual widget definitions 41 could be formatted as follows:

```
OK THEME
      THEME_ID=”http://www.nokia.com/classic/2004”
      <widget_definition_data>
```

Such a response is transmitted by the repository 20 to the device 10 at step 4. Upon receiving the response, the device 10, more specifically the processor 19, proceeds to either fetch the widget definitions from the URIs given in step 4, or alternatively, widget definitions 41 are extracted from the <widget_definitiondata> portion of the reply.

Finally, at step 5, the processor 19 changes the appropriate user interface settings in accordance with the newly received widgets and the user interface of the device is thereby changed accordingly.

As is evident, the system described above alleviates the need to store every widget definition 41 forming a given theme in a discreet theme package. A single widget definition 41 can be used by multiple themes. In addition, it is not necessary to send to a device 10 all of the UI data related to a requested theme. As noted above, theme data, that includes all relevant, requested widget definitions 41, can be dynamically formed of only widget definitions 41 compatible with the device from which a query is received, or which were specifically requested by a device 10.

In addition, a user of a device 10 does not have to engage in a complicated procedure to acquire all of the widget definitions 41 comprising a theme package. A user need only browse the available themes in the repository 20 and select one. The user's device 10 need only request the necessary widget definitions 41 and the remote repository 20 assembles the requested theme data on the fly and send it to the device 10.

In an alternative exemplary embodiment, the repository 20 is utilized to store UI data formed of icons. Icons are often application specific. Icons corresponding to particular applications are generally displayed and serve an access means through which an application can be invoked. As a result, loading an application onto a device 10 which is implementing a particular theme may result in a situation where the resident icon for the application does not match the theme. This is particularly possible when utilizing an application and accompanying icon that was developed and loaded onto the device 10 prior to the definition of the theme.

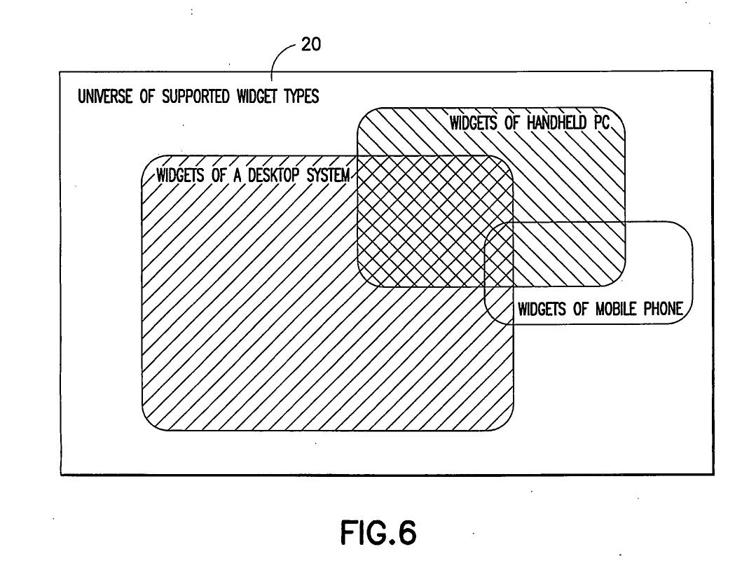

Typically, if a user interface is implementing a theme that lacks a theme compliant icon for an application, a default icon is utilized. Such a substitution often times results in a user interface that has an unattractive mixture of design elements, as is illustrated with reference to FIGS. 7a-b. In FIG. 7a, a theme is implemented on a user interface 15 wherein not all of the icons 71 are compliant with the theme. Note that the icon 71a for the application “Video rec.” appears flat while other icons 71, such as an icon 71b for “Application” appear in perspective. This is a result of the use of a default icon 71 for the “Video rec.” application in concert with a theme supporting perspective view icons 71.

With reference to FIG. 7b, there is illustrated a user interface 15 implementing a theme in which all of the application icons 71″ are theme compliant. Note, for example, how the icon 71a′ for the application “Video rec.” is in perspective. In accordance with this exemplary embodiment of the invention, a device 10 with access to a repository 20 on which is stored UI data including icon definitions can request and receive icon definitions that are not resident on the device.

In an exemplary embodiment, two pieces of information are used to obtain an icon definition from the remote repository 20. The first is the theme id and the second is the application id. As noted above with reference to theme packages formed of widget definitions 41, the theme id can be created using a method similar to the way in which XML namespaces are defined. Regarding an application id, in the context of an exemplary system like Symbian™, each application is required to register a unique id with the Symbian™ company. Therefore, with systems utilizing a Symbian™ operating system the application id used in the lookup on the repository 20 can be the official id registered with Symbian™. On systems other than Symbian™, the application id could also be determined in a manner similar to the way in which XML namespaces are defined.

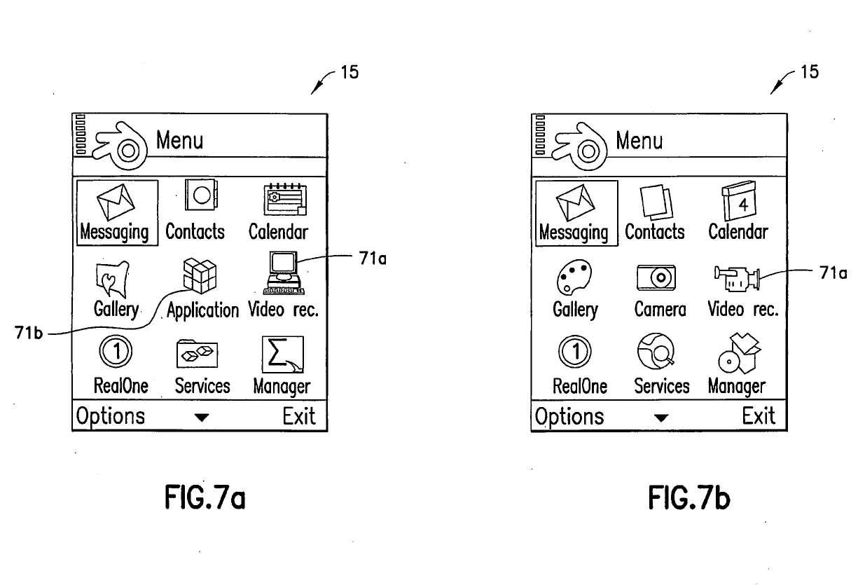

With reference to FIG. 8, there is illustrated a logic flow diagram of the method by which icons are requested, received, and implemented. At step 1, the user interface 15 of the device has been updated, as, for example, with a new theme, as illustrated in step 5 of FIG. 5. At step 2, the device 10, in particular the processor 19, queries to see what applications are installed on the device 10 that are not defined on the device 10 and are therefore required from the repository 20.

At step 3, the device 10 queries the repository 20 for the icon definitions corresponding to the undefined applications. A query is sent from the device 10 to the repository 20, via link 17, that is comprised of either a skin id or a theme id and the application ids of the applications for which there are required icon definitions. For example, the query can be executed via HTTP and the query formatted as follows:

GET ICON APP_ID=”483920432”
THEME_ID=”http://www.nokia.com/classic/2004”

At step 4, the repository 20 responds to device 10 with either the icon definitions or the URI where the icon definitions can be obtained. For example, a response that returns the actual icon definition could take a format like the following:

OK ICON APP_ID=”483920432”
THEME_ID=”http://www.nokia.com/newtheme/2004” <icon_data>

The icon data may be formed of an image or images at different resolutions or may be defined in a scale independent manner, such as in SVG format. At step 5, the device 10 fetches the needed icons from the URIs provided in the response from the repository 20 in step 4 if necessary, or, otherwise, the device 10 utilizes the icon definitions as given by the repository 20 and updates the icons displayed on user interface 15 so as to provide the user interface 15 with a uniform look and feel.

Note that the example query from the device 10 and the subsequent response from the repository 20 demonstrated above show the minimal information required for processing a request. Additional information could also be included with the query to further narrow down the appropriate icon definition. For example, the desired display resolution of the icon could be passed with the request. This would aid in determining the level of detail desired by the device 10. Other relevant pieces of data could also be passed with each query or response.

In an alternative embodiment, there is provided a technique by which a device 10 can query a repository 20 for style information related to a theme. As noted above, loading and executing an application on a device 10 can result in a situation where icon definition data related to the application is not resident on the device 10. In such a situation, the repository 20 can be queried to provide icon definition data. In a more general sense, a device 10 may have resident various applications, icons, and widgets which require rendering in the user interface 15 but which are not compliant with the theme being displayed and which are not defined in the repository 20 for the specified theme. In such instances, it is common to resort to rendering default user interface elements such as default widgets and default icons. The use of default elements can result in an unattractive mixture of visual design elements, specifically user interface elements.

By storing style definitions in the repository 20, it is possible to define and store the general aesthetic constructs which underlie a theme. Once defined, the style definition can be utilized to generate user interface elements, such as icons or widgets, which are not individually defined in the repository 20 but which are generally in accord with a desired theme.

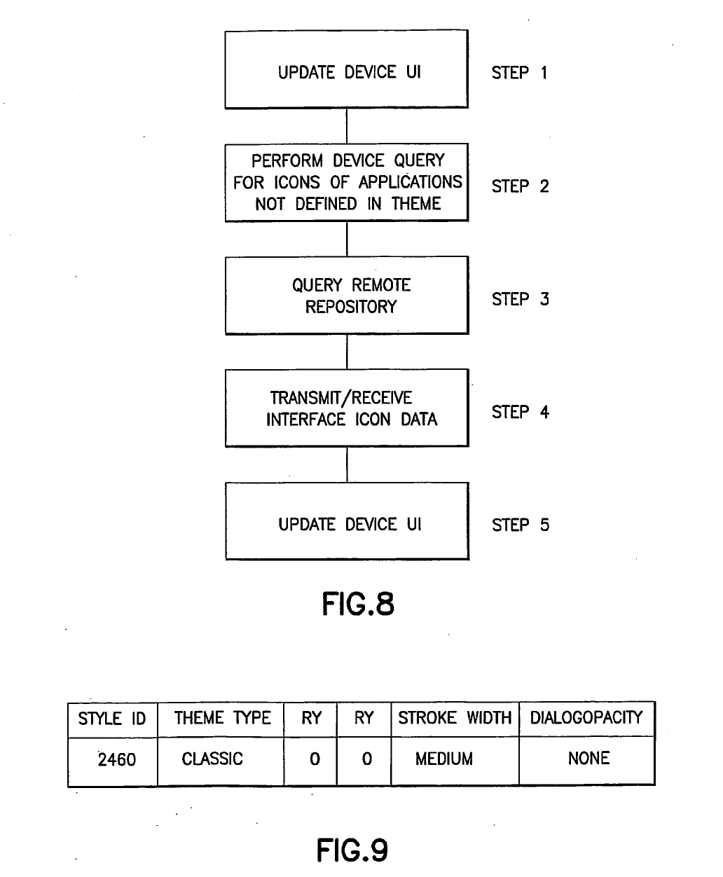

With reference to FIG. 9, there is illustrated an exemplary table entry, such as might be employed in a relational database on repository 20, of a style definition. The style is defined by an id of “2460”. Other columns of the table indicate that the style having a style id of “2460” is compliant with the theme type “classic”. In addition, several general style attributes are included which serve to define the overall aesthetic attributes of the style. For example, “rx” and “ry” define the curvature of various user interface elements. As each have a value of “0”, user interface elements will tend to be square. In a similar manner, other user interface elements are defined to have a line stroke width of “medium” and a dialog-opacity of “none”. While these attributes are shown as related to an entire style, they could likewise be defined on an element basis. For example, a user interface element such as a command button could be specified to be rounded (button.command.rx=high, button.command.ry=high) while radio buttons are defined to be square (button.radio.rx=0, button.radio.ry=0).

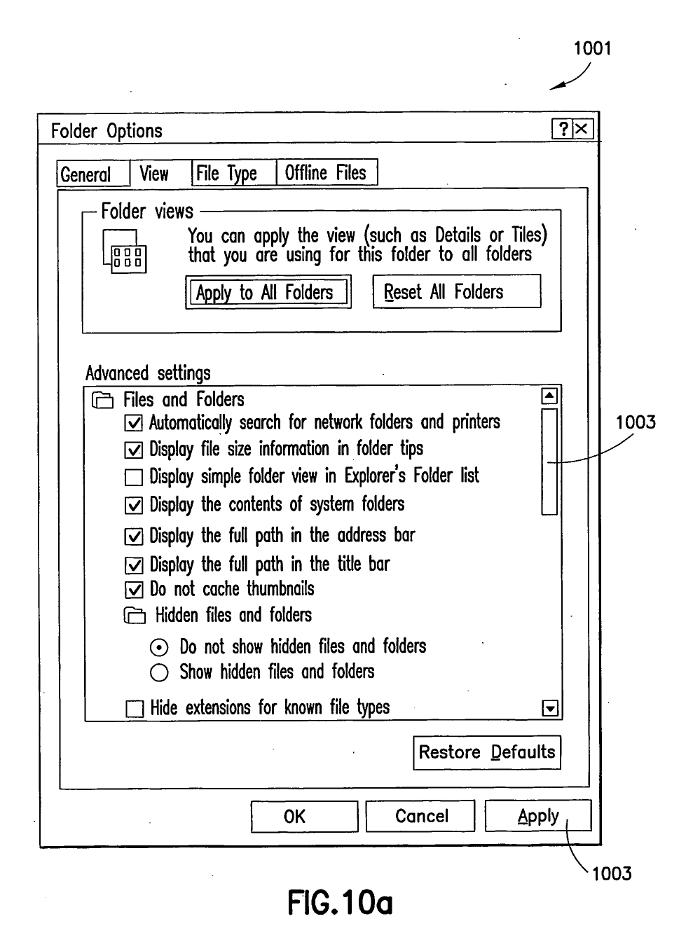

With reference to FIGS. 10a-10b, there are illustrated exemplary windows 1001 as might be viewed on a user interface. With reference to FIG. 10a, a style is employed which includes style properties such as “rx=0”, “ry=0”, “stroke width=medium, and “dialog-opacity=none”. Note the generally square elements 1003. Conversely, FIG. 10b illustrates an exemplary window 1001 which includes style properties such as “rx=medium”, “ry=medium”, “stroke width=thin, and “dialog-opacity=25%”. Note the generally rounded elements 1003.

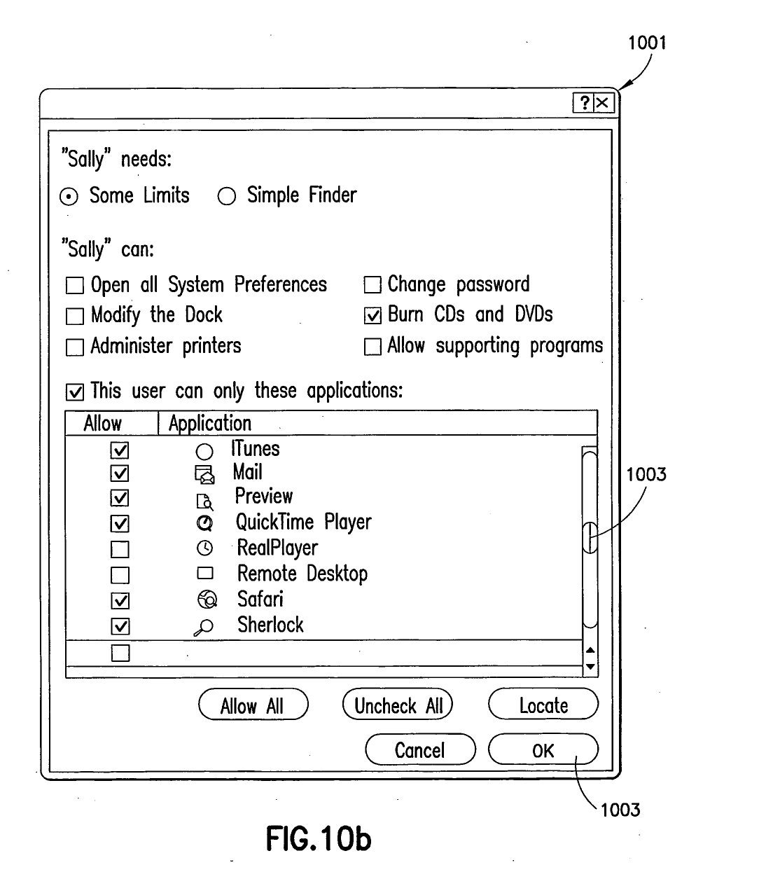

With reference to FIG. 11, there is illustrated a logic flow diagram of the method by which style definitions and data can be requested by a device 10 and responded to by a repository 20. Typically, at step 1, a user interface has been updated to incorporate a theme. In the instance that the device 10 is required to display a user interface element such as a widget, a control, an icon, or the like which is not defined by the style, the device 10 forms a query to request the style definition associated with the theme at step 2.

For example, the query may be issued over link 17 in the form of an HTTP formatted request as follows:
GET STYLE THEME_ID=″http://www.nokia.com/classic/2004″

At step 3, the repository 20 retrieves the requested style information and formats a reply. For example, a response that returns the style information could take a format like the following:

OK STYLE THEME_ID=”http://www.nokia.com/newtheme/2004”
<style_data>

At step 4, the response is transmitted from the repository 20 to the device 10 and the device 10, at step 5, alters the appropriate user interface settings for the desired user interface elements as specified in the style definition data thus giving the device now has a consistent new look and feel. As a result, any user interface elements that were not defined in the theme can now be rendered with the modifications specified in the style data from the remote repository.

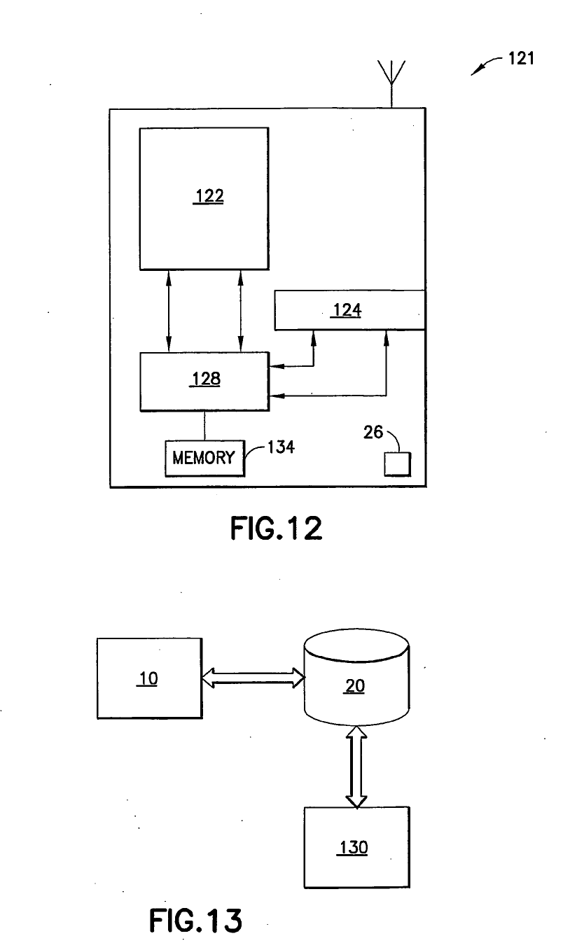

With reference to FIG. 13, there is illustrated an exemplary embodiment of a system for practicing the invention. Repository 20 is in communication, preferably bi-directional communication, with both at least one device 10, and a user interface element provider 130. In such a configuration, designers and providers of user interface elements 130 can store their creations on the repository 20 for use by a multitude of devices 10.

As noted above, the invention may be practiced on a mobile station, in particular, a mobile phone. A mobile station (MS) is a handheld portable device that is capable of wirelessly accessing a communication network, such as a mobile telephony network of base stations that are coupled to a publicly switched telephone network. A cellular telephone, a Blackberry® device, and a personal digital assistant(PDA) with internet or other two-way communication capability are examples of a MS. A portable wireless device includes mobile stations as well as additional handheld devices such as walkie talkies and devices that may access only local networks such as a wireless localized area network (WLAN) or a WIFI network.

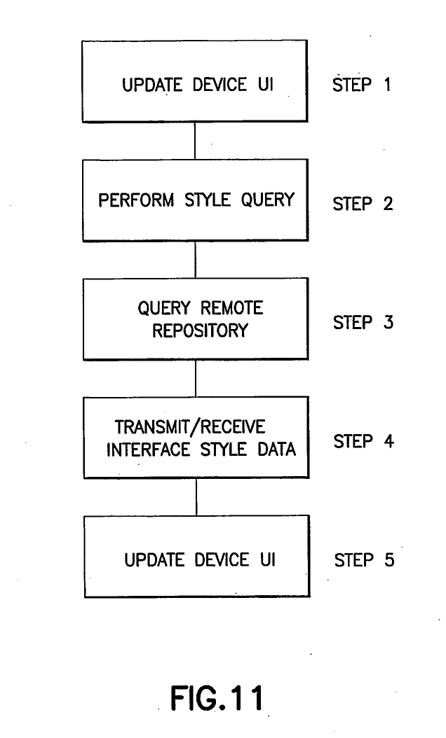

FIG. 12 illustrates in block diagram form a mobile station MS 121 in which the present invention may preferably be disposed. These blocks are functional and the functions described below may or may not be performed by a single physical entity as described with reference to FIG. 12. A display 122, and an input user interface 124, such as a unit for receiving inputs from an array of user actuated buttons, are provided for interfacing with a user. The MS 121 further includes a power source 26 such as a self-contained battery that provides electrical power to a central processor 128 that controls functions within the MS 120. Within the processor 128 are functions such as digital sampling, decimation, interpolation, encoding and decoding, modulating and demodulating, encrypting and decrypting, spreading and despreading (for a CDMA compatible MS 121), and additional signal processing functions known in the art.

Computer programs such as drivers for the display 122, algorithms to modulate, encode and decode, data arrays such as look-up tables, and the like are stored in a main memory storage media 134 which may be an electronic, optical, or magnetic memory storage media as is known in the art for storing computer readable instructions and programs and data. In an exemplary embodiment of the invention, the main memory 134 stores a computer program for implementing the invention.

It is understood that the various exemplary embodiments described herein may be implemented in hardware or special purpose circuits, software, logic or any combination thereof. For example, some aspects may be implemented in hardware, while other aspects may be implemented in firmware or software which may be executed by a controller, microprocessor, processor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in hardware, software, firmware, special purpose circuits or logic, general purpose hardware or controller or other computing device, or some combination thereof.

Alternative exemplary embodiments of the invention may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys™, Inc. of Mountain View, Calif. and Cadence Design™, of San Jose, Calif. automatically route conductors and locate components on a semiconductor chip using well established rules of design as well as huge libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

While there has been illustrated and described what is at present considered to be preferred embodiments of the invention, it will be appreciated that numerous changes and modifications are likely to occur to those skilled in the art. It is intended in the appended claims to cover all those changes and modifications that fall within the spirit and scope of the claimed invention.

What is claimed is:

1. A method comprising:
receiving a query from a remote device for at least one user interface element; and
dynamically retrieving response data from a repository comprising a plurality of user interface element definitions in response to said query, wherein dynamically retrieving comprises specifically selecting the at least one user interface element from said repository.

2. The method of claim 1 wherein said query comprises a theme id.

3. The method of claim 2 wherein said query comprises at least one widget type.

4. The method of claim 3 wherein said at least one widget type comprises all widget types supported by said device.

5. The method of claim 3 wherein said response data comprises at least one widget definition.

6. The method of claim 3 wherein said response data comprises a location of at least one widget definition.

7. The method of claim 6 wherein said location is a uniform resource identifier.

8. The method of claim 1 wherein said query comprises at least one application icon id.

9. The method of claim 8 wherein said response data comprises at least one application icon definition.

10. The method of claim 8 wherein said response data comprises a location of at least one application icon definition.

11. The method of claim 9 wherein said query comprises an icon resolution and said at least one application icon definition comprises the icon resolution.

12. The method of claim 9 wherein said application icon definition is in a scalable vector graphics (SVG) format.

13. The method of claim 1 wherein said query requests at least one style definition.

14. The method of claim 13 wherein said response data comprises style data.

15. The method of claim 1 wherein said device comprises a mobile phone.

16. The method of claim 1 wherein said remote repository comprises a relational database.

17. A system comprising:
means for receiving from a remote device a query for at least one user interface element; and
means for dynamically retrieving response data from said repository in response to said query, wherein said means for dynamically retrieving comprises means for specifically selecting the at least one user interface element from a database coupled to said repository.

18. The system of claim 17 wherein said device comprises a mobile phone.

19. The method of claim 17 wherein said remote repository comprises a relational database.

20. A program of machine-readable instructions, tangibly embodied on an information bearing medium and executable by a digital data processor, to perform actions directed toward modifying a user interface, the actions comprising:
forming a query to specifically request at least one user interface element not resident upon a device;
transmitting said query to a remote repository comprising a plurality of user interface element definitions;
receiving a response from said remote repository comprising at least one user interface element definition; and
modifying a user interface of said device in response to said response.

21. The program of claim 20 wherein said query comprises a theme id.

22. The program of claim 21 comprises at least one widget type.

23. The program of claim 21 wherein said query comprises at least one application icon id.

24. The program of claim 21 wherein said query comprises at least one style definition.

25. The program of claim 20 wherein said device comprises a mobile phone.

26. The program of claim 20 wherein said transmitting and receiving occurs via a wireless connection.

27. A program of machine-readable instructions, tangibly embodied on an information bearing medium and executable by a digital data processor, to perform actions directed toward modifying a user interface, the actions comprising:
receiving a query from a device for at least one user interface element resident upon a repository remote from said device;
dynamically forming a response to said query comprising at least one user interface element definition; and
transmitting said response to said device.

28. The program of claim 27 wherein said repository comprises a relational database.

29. The program of claim 27 wherein said device comprises a mobile phone.

30. A method comprising:
forming a query to specifically request at least one user interface element not resident upon a device;
transmitting said query to a remote repository comprising a plurality of user interface element definitions;
receiving a response from said remote repository comprising at least one user interface element definition; and
modifying a user interface of said device in response to said response.

31. The method of claim 30 wherein said query comprises a theme id.

32. A device comprising:
means for forming a query to specifically request at least one user interface element not resident upon a device;
means for transmitting said query to a remote repository comprising a plurality of user interface element definitions;
means for receiving a response from said remote repository comprising at least one user interface element definition; and
means for modifying a user interface of said device in response to said response.

33. The device of claim 32 wherein said query comprises a theme id.

34. A server comprising:
means for receiving a query from a remote device for at least one user interface element; and
means for dynamically retrieving response data from a repository comprising a plurality of user interface element definitions in response to said query, wherein dynamically retrieving comprises specifically selecting the at least one user interface element from said repository.

35. The server of claim 34 wherein said device comprises a mobile phone.

36. A method comprising:
providing a repository;
receiving a plurality of user interface elements from at least one user interface element provider;
storing said plurality of user interface elements in said repository; and
retrieving at least one of said plurality of user interface elements in response to a query.
